(19) United States
(12) Patent Application Publication
(10) Pub. No.: US 2026/0299349 A1
(43) Pub. Date: Oct. 1, 2026

(54) DISPLAY DEVICE AND ELECTRONIC APPARATUS

(71) Applicant: Kepler Corp., Tokyo (JP)

(72) Inventors: Takahiro ISHINABE, Tokyo (JP); Kosho TSUBOI, Tokyo (JP)

(21) Appl. No.: 19/479,353

(22) PCT Filed: Apr. 15, 2024
(86) PCT No.: PCT/JP2024/014924

§ 371 Date: Oct. 28, 2025

(30) Foreign Application Priority Data
Apr. 28, 2023 (JP) 2023-074574

(51) Int. Cl. G02F 1/1335; G02F 1/133; G09G 3/36

(52) U.S. Cl. CPC G02F 1/133504; G02F 1/13312; G02F 1/133562; G09G 3/36; G09G 2320/0626

(57) ABSTRACT

This display device has, on the side closest to an observer, a surface layer that has light-transmitting properties and an irregular uneven shape on the observer side. In the surface layer, the arithmetic average roughness Ra of the uneven shape is 10-3000 μm, and the haze value is 40-85%.

In the display device, a distance from the lowest point of the uneven shape to an image forming layer for forming an image to be displayed is 0.3 mm or less, and in a surface on which the surface layer is laminated, a reduction rate of luminance in a direction forming 60° with respect to a normal direction of the surface when luminance in the normal direction is used as a reference is 45% or less. The display device is provided with: a sensor unit that detects brightness and color of external light incident on a display surface; and an image adjustment unit that adjusts the brightness and color of the image.

### TECHNICAL FIELD

The present invention relates to a display device and an electronic apparatus.

### BACKGROUND ART

Various display devices such as a liquid crystal display and an organic EL display have conventionally been used in various environments and applications. In addition, image display techniques in which image information of an image to be displayed by a display device is made congruent with the environment in which the display device is used so that an observer can visually perceive and discern the texture of an object displayed as the image have been proposed and put into practical use.

For example, Patent Document 1 discloses one of such techniques. According to the method disclosed in Patent Document 1, a display device includes a sheet printed with a wood grain pattern or the like that is congruent with an environment in which the display device is used, a plurality of fine holes are arranged in a display surface of the sheet, and an image is projected from the back side of the sheet. The method of Patent Document 1 reduces the likelihood that an observer visually perceives a black screen in a state in which no image is displayed and the display device appears incongruent with the environment, thereby improving the design. In addition, there is also a known method in which brightness, color, and the like of external light around a display device are detected by a sensor or the like, and a color tone or the like of an image to be displayed on a display surface is adjusted in accordance with the information.

### CITATION LIST

### Patent Document

Patent Document 1: PCT International Publication No. WO 2020/196906

### DISCLOSURE OF THE INVENTION

### Problems to be Solved by the Invention

However, according to the former method, the image resolution decreases, making it difficult to display a clear image. Furthermore, in both methods, when external light is reflected on the display surface of the display device, a smooth surface shape of the display surface is perceived by the observer, making it difficult to represent the texture of an object. In particular, when an object having an uneven surface shape with fine projections and depressions, such as stone, wood, paper, fabric, or an oil painting, is displayed as an image on the display surface, it is difficult to represent the texture of the object due to incongruity between the displayed image and the surface shape of the display surface that the observer visually perceives.

The present invention was made in view of the above-described disadvantages, and intends to provide a display device and an electronic apparatus that are capable of displaying an image of an object having an uneven surface shape with fine projections and depressions, e.g., wood, stone, paper, a painting such as an oil painting, fabric, and the like, in such a manner as to allow an observer to discern the texture of the object, and are capable of improving the design quality of the object.

### Means for Solving the Problems

(1) A display device displays an image on a display surface and includes: a surface layer disposed closest to an observer side, having light transmittance, and having an uneven shape with projections and depressions on a side facing the observer side. The uneven shape has an arithmetic mean roughness Ra of 10 μm or greater and 3000 μm or less, the surface layer has a haze value of 40% or greater and 85% or less, in a thickness direction of the display device, a distance from a bottommost point in the uneven shape to an image-forming layer configured to form the image to be displayed is 0.3 mm or less, and on a surface with the surface layer laminated thereon, a luminance at an observation angle of 60° with respect to a normal direction of the surface is lower by a percentage decrease of 45% or less relative to a luminance in the normal direction of the surface. The display device further includes a sensor unit configured to detect brightness and color of external light incident on the display surface, and an image adjustment unit configured to adjust brightness and color of the image to be displayed by the display device based on information regarding the brightness and color of the external light detected by the sensor unit.
(2) It is preferable that in the uneven shape, the depressions have irregular depths, the projections have irregular heights, and the projections and the depressions are in an irregular distribution in a plane direction of the surface layer.
(3) It is preferable that haze values of an outermost surface of the uneven shape are in an irregular distribution in a plane direction of the surface layer.
(4) It is preferable that external light incident on the display device has a specular reflectance of 1% or less inside the display device.
(5) An electronic apparatus includes the display device according to any one of (1) to (4).

### Effects of the Invention

The present invention can provide a display device and an electronic apparatus that are capable of displaying an image of an object having an uneven surface shape with fine projections and depressions, e.g., wood, stone, paper, a painting such as an oil painting, fabric, and the like, in such a manner as to allow an observer to discern the texture of the object, and are capable of improving the design quality of the object.

### BRIEF DESCRIPTION OF THE DRAWINGS

FIG. 1 is a perspective view illustrating an electronic apparatus 1 according to an embodiment;

FIG. 2 is a diagram illustrating one example of use of the electronic apparatus 1 according to the embodiment;

FIG. 3 is a diagram illustrating a layered structure of a display device 10 according to an embodiment;

FIG. 4 is a block diagram illustrating a configuration of the display device 10 according to the embodiment;

FIG. 5 is an enlarged view of a portion of a cross section of a surface layer 15 according to the embodiment;

FIG. 6 is a diagram illustrating a configuration of a display device of Measurement Example 1;

FIG. 7 is a diagram illustrating a configuration of a display device of Measurement Example 2;

FIG. 8 is a graph showing a luminance distribution on a light-emitting surface 12a of a display panel 12 of the display devices of Measurement Examples 1 and 2;

FIG. 9 is a diagram illustrating a distance S in a display device of an arbitrary one of measurement examples;

FIG. 10 is a table showing evaluation results of textures of images displayed by display devices of Measurement Examples 3 to 28;

FIG. 11 is a table showing evaluation results of the textures of images displayed by display devices of Measurement Examples 29 to 38;

FIG. 12 is a photograph showing an example of the electronic apparatus 1 and the display device 10 including, in a portion of a light-releasing surface 12a, a surface layer 15 having an uneven shape with projections and depressions satisfying preferable ranges of an arithmetic mean roughness Ra, a haze value, and a distance S;

FIG. 13 is an enlarged view of a portion of a cross section of a surface layer 35 according to another embodiment 1;

FIG. 14 is a photograph showing a state of a surface of a laminate 40; and

FIG. 15 is a diagram illustrating a layered structure of a laminate 70.

### PREFERRED MODE FOR CARRYING OUT THE INVENTION

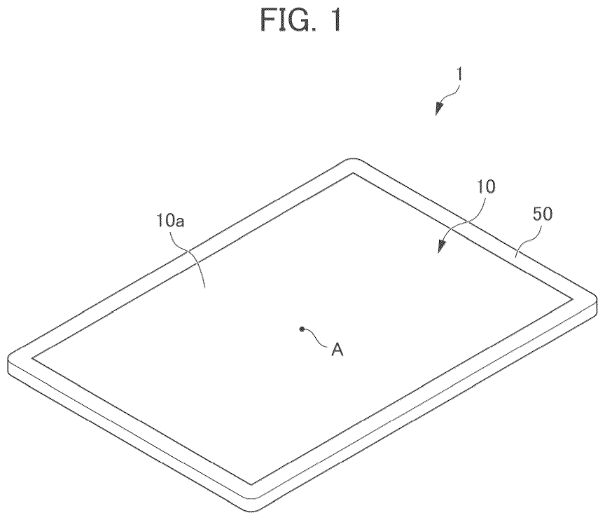

Embodiments of the present invention will be described below with reference to the drawings and the like. The drawings including FIG. 1, which will be referred to below, are schematic diagrams, and the sizes and shapes of the illustrated components are exaggerated as appropriate for ease of understanding. Numerical values such as dimensions and the like and material names of the members described in the present specification are examples as embodiments, are not intended to limit the present invention, and may be appropriately selected and employed. In the present specification, a term specifying a shape or a geometric condition, such as “parallel”, “orthogonal”, etc., encompasses, in addition to its strict meaning, a state in which a similar optical function is performed and which has an error but can be regarded as parallel or orthogonal.

### Embodiments

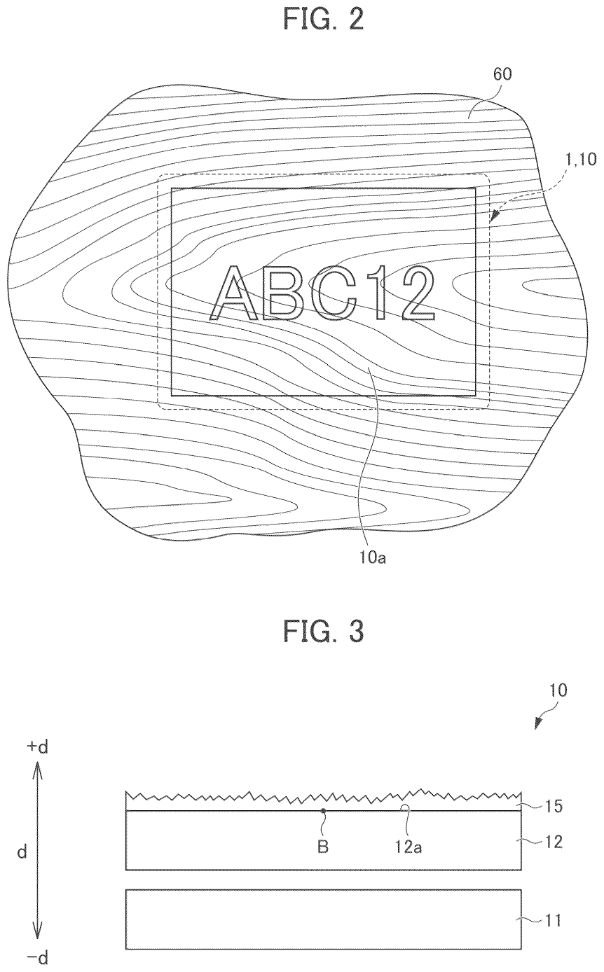

FIG. 1 is a perspective view illustrating an electronic apparatus 1 according to the present embodiment. FIG. 2 is a diagram illustrating one use example of the electronic apparatus 1 according to the present embodiment. As illustrated in FIG. 1, the electronic apparatus 1 according to the present embodiment is a tablet terminal including a display device 10 having a display surface 10a (screen) that displays an image, a housing 50 that holds the display device 10, an input/output unit (not illustrated), a communication unit (not illustrated), a control unit (not illustrated) that controls the electronic apparatus 1, and the like. The input unit includes an input device such as a mouse, a keyboard, a touch panel, and a button, receives operation information, and outputs the operation information to the control unit of the electronic apparatus 1. The communication unit is a module for performing processing related to communication. By means of the communication unit, the control unit of the electronic apparatus 1 can transmit and receive information through a network (not shown), and can communicate with, for example, a personal computer or the like disposed externally of the electronic apparatus 1.

The electronic apparatus 1 is not limited to the above-described tablet terminal, and may be a smartphone, an electronic book reader, a digital photo frame, a display device for displaying a painting and a non-fungible token (NFT) art, an electronic textbook, or the like. The electronic apparatus 1 according to an embodiment of the present invention is not limited to these examples.

As illustrated in FIG. 2, the electronic apparatus 1 of the present embodiment is embedded in, for example, a wall surface 60 formed of a wood board, and is disposed so that the periphery of the display surface 10a is surrounded by the wood board. Therefore, an observer visually perceives the wood grain pattern of the wall surface 60 around the display surface 10a. The present embodiment will be described by referring to an example in which the electronic apparatus 1 and the display device 10 display an image with characters or the like drawn on a wood grain pattern, as illustrated in FIG. 2. The wood grain pattern of the image is congruent with the wood grain pattern of the wood forming the wall surface around the display device. The display device 10 with this configuration can be used, for example, to display a sales promotion advertisement, a menu, etc. in a store, and has an advantage that the displayed textual information and the like can be easily changed. The electronic apparatus 1 and the display device 10 according to the present embodiment will be described by referring to an example in which the display surface 10a (screen) has a rectangular shape, but the shape of the display surface 10a is not limited to the rectangular shape.

In the case of conventional, general display device and electronic apparatus, even when an image of a wood grain pattern of wood with characters or the like written thereon is displayed, an observer perceives the image as a flat image displayed on the display surface by the observer, and the image is unlikely to appear congruent with the wood of the surrounding wall surface 60. In contrast, in a case where the display device 10 and the electronic apparatus 1 according to the present embodiment display the image on the display surface 10a, the observer can discern the texture of the wood grain pattern of wood with characters or the like written thereon, thereby making it possible to display the image in such a manner as to make the image congruent with the surrounding environment. The display device 10 and the electronic apparatus 1 are not only applicable to the wood grain texture of a surface of wood, but are also capable of displaying an object having an uneven surface shape with projections and depression, such as stone, paper, a painting such as an oil painting, and fabric, on the display surface 10a such that the observer can discern the texture of the object.

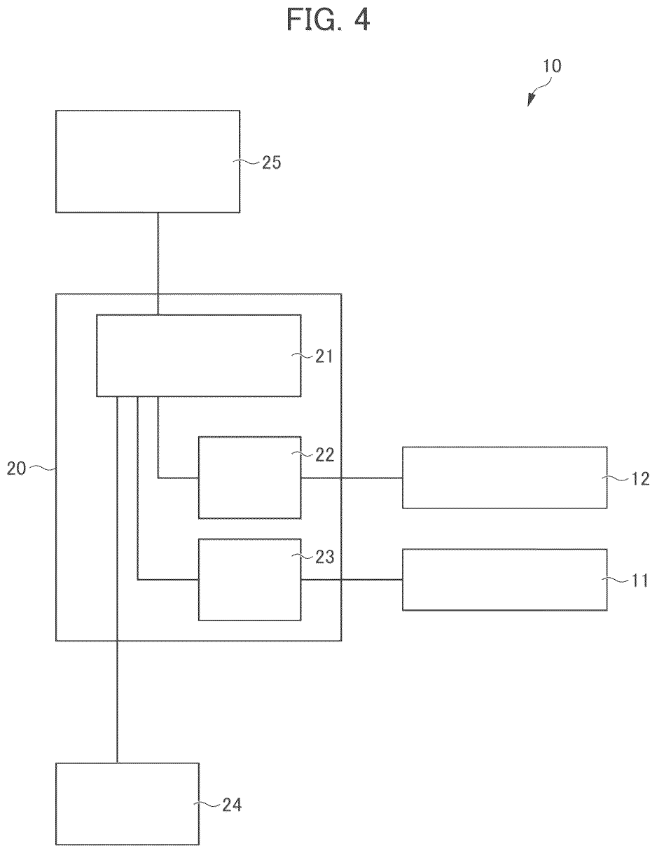

FIG. 3 is a diagram illustrating a layered structure of the display device 10 according to the present embodiment. FIG. 4 is a block diagram illustrating a configuration of the display device 10 according to the present embodiment. The display device 10 of the present embodiment is a transmissive liquid crystal display device (liquid crystal display) including a backlight 11, a display panel 12, a surface layer 15, a display control unit 20, a storage unit 24, and a sensor unit 25. To facilitate understanding, FIG. 3 and other figures to be described later show an arrow d indicating a direction parallel to a thickness direction of the display device 10 as necessary. In the d direction, the back side of the display device 10 is defined as a −d side, and the observer side is defined as a +d side.

The display device 10 causes the backlight 11 to illuminate the display panel 12 from the back side, and displays, on the display surface 10a, image information formed on the display panel 12. Many general display devices tend to have a wide viewing angle in the left-right direction of the screen and a narrow viewing angle in the up-down direction of the screen, although the viewing angles depend on the usage of the display device. On the other hand, the viewing angles of the display device 10 of the present embodiment are equally wide or vary slightly regardless of the direction in plane of the screen, and therefore, the display device 10 displays an image the brightness of which does not change or changes slightly regardless of the direction in which the image is observed.

The backlight 11 is a surface light source device that illuminates the display panel 12 from the back side (−d side). In the present embodiment, the backlight 11 may be an edge-light type surface light source device including a light guide plate and the like, or may be a direct type surface light source device. A general-purpose light source device can be used as the backlight 11.

A known edge-light type backlight includes a plurality of light-emitting diodes (LEDs) or the like serving as a light source, a light guide plate that guides light from the light source, a reflective film, and various optical sheets such a light diffusion sheet that diffuses light from the light guide plate, a prism sheet that controls a light emitting direction, and a reflective polarizing sheet that increases utilization efficiency of predetermined polarized light. A known direct type backlight includes, as appropriate, a plurality of LEDS or the like serving as a light source and arranged on a back side facing a light-emitting surface, a reflective film, and various optical sheets such as the above-mentioned light diffusion sheet, prism sheet, and reflective polarizing sheet.

The display panel 12 is constituted by a plate-shaped member including a highly transparent glass plate as a substrate, and is a transmissive display unit that displays image information on the display surface 10a of the display device 10. The display panel 12 may be constituted by a film-shaped member including a highly transparent polyimide film as a substrate. The display panel 12 of the present embodiment is a transmissive liquid crystal panel including an electrode layer, a polarizing layer, a liquid crystal layer, and the like, which are not shown. The display panel 12 preferably adopts, as the method for driving the liquid crystal layer, a method that achieves a wide range of viewing angle, such as VA method, IPS method, an FFS method.

In the display device 10 of the present embodiment, the surface layer 15 is laminated on a light-releasing surface 12a of the display panel 12. It is preferable that the light-releasing surface 12a has a gentle luminance distribution, and that the display device 10 according to the present embodiment has a wide viewing angle characteristic that a decrease in luminance is smaller when viewed in an oblique direction than when viewed in a front direction, or that the luminance does not decrease. Preferably, the display surface 10a of the display device 10 and the electronic apparatus 1 have Lambertian distribution in which the luminance distribution is gentle in both the left-right and up-down directions of the screen. In the display device 10 according to the present embodiment, a center point of the display surface 10a is defined as a point A (see FIG. 1), and a center point of the light-releasing surface 12a corresponding to the point A is defined as a point B. It is preferable that a luminance in a direction that forms 60° at the point B with the normal direction of the light-releasing surface 12a (luminance at an observation angle of 60°) is lower by a percentage decrease of 45% or less relative to a luminance in the normal direction of the light-releasing surface 12a (a luminance at an observation angle of 0°; front luminance).

The surface layer 15 is laminated on the light-releasing surface 12a of the display panel 12, and is located closest to the observer side (+d side) in the display device 10. The surface layer 15 may be integrally laminated on the light-releasing surface 12a, or may be bonded to the light-releasing surface 12a with a highly transparent bonding layer (not shown). The bonding layer may have light diffusivity. The surface layer 15 is a film-shaped or sheet-shaped member, has light transmittance, and has a shape with fine, irregular projections and depressions on its surface facing the observer side. The surface layer 15 has a function of improving the texture of an object displayed as an image on the display surface of the display device 10. Due to being disposed on the light-releasing surface 12a, the surface layer 15 can improve not only the texture of wood as in the present embodiment, but also the texture of an image of an object having an uneven surface shape with fine, irregular projections and depressions, such as stone, paper, a painting such as an oil painting, cloth, a knitted fabric, a woven fabric, and the like.

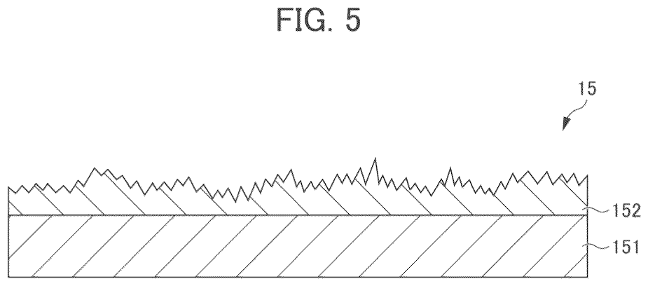

FIG. 5 is an enlarged view of a portion of a cross section of the surface layer 15 of the present embodiment. The surface layer 15 of the present embodiment includes a base material layer 151 and a projections-depressions layer 152. The surface layer 15 diffuses, by means of its uneven shape with projections and depressions and the like, the light released from the light-releasing surface 12a of the display panel 12. The diffusion effect is not directional.

The base material layer 151 is a sheet-shaped or film-shaped resin member having light transmittance. Examples of a resin suitable for forming the base material layer 151 include, but are not limited to, thermoplastic resins such as PC (polycarbonate), MBS (methacrylate-butadiene-styrene copolymer), MS (methacrylate-styrene copolymer), PET (polyethylene terephthalate), PS (polystyrene), TAC (triacetyl cellulose), etc. However, the base material layer 151 may be made of another resin. The base material layer 151 preferably has a thickness of 20 μm to 100 μm, and more preferably 30 μm to 50 μm.

The projections-depressions layer 152 is formed on a surface of the base material layer 151 facing the observer side (+d side) in the thickness direction (d direction), and has an uneven shape with fine, irregular projections and depressions on a surface facing the observer side. The projections-depressions layer 152 is integrally formed on the one surface of the base material layer 151. The projections-depressions layer 152 is formed of, for example, an ultraviolet curable resin such as urethane acrylate, polyester acrylate, epoxy acrylate, or the like. The projections-depressions layer 152 may be formed of an ionizing radiation curable resin such as an electron beam curable resin.

The projections and depressions of the projections-depressions layer 152 preferably have irregular sizes (irregular heights of the projections and irregular depths of the depressions) and are arranged at positions in an irregular distribution. However, the projections and depressions of the projections-depressions layer 152 may have periodicity or the like in accordance with an object to be displayed as an image. The projections and depressions can be formed by the following method, for example: an ultraviolet curable resin or the like is applied to one surface of the base material layer 151, a mold for shaping the projections and depressions is pressed onto the resultant coating film to shape (transfer) the shapes of the projections and depressions, and the ultraviolet curable resin is cured by irradiation of ultraviolet rays. The method of forming the projections-depressions layer 152 is not limited to this, and may be appropriately selected. The mold for shaping the projections and depressions may be made to have a reverse shape of the projections and depressions by way of moulage of a surface of an object (in the present embodiment, the surface of a wood board) the texture of which is to be improved when displayed as an image.

The uneven shape with projections and depressions of the surface layer 15 may be set to have a preferred cross-sectional shape in accordance with an object to be displayed as an image on the display surface 10a, and the angles of the projections and depressions, the sharpness of the top portion of the projections or the like can be appropriately set. From the viewpoint of enhancing the texture of an object displayed as an image, the arithmetic mean roughness Ra (JIS B 0601:2001) of the uneven shape with projections and depressions is preferably 10 μm or greater and 3000 μm or less. In a case where the arithmetic mean roughness Ra of the uneven shape is less than 10 μm, the projections and depressions decrease in size so that the surface of the surface layer 15 is nearly flat. Consequently, image light cannot be sufficiently diffused, whereby the texture cannot be improved. In a case where the arithmetic mean roughness Ra of the uneven shape is greater than 3000 μm, the sizes of the projections and depressions are excessively large so that the blur of the image increases, whereby the texture cannot be improved. Therefore, the arithmetic mean roughness Ra of the uneven shape is preferably in the above-described range. The arithmetic mean roughness Ra of the uneven shape can be measured using a laser microscope (VK-9710 manufactured by Keyence Corporation) or the like.

When the arithmetic mean roughness Ra of the uneven shape is within the above-described preferred range, the surface layer 15 can improve the texture of an object (wood, stone, paper, fabric, a painting, or the like) displayed as an image. The optimum range of the arithmetic mean roughness Ra varies depending on the object the texture of which is to be enhanced.

From the viewpoint of representing the texture, the surface layer 15 preferably has a haze value of 40% or greater and 85% or less. In a case where the haze value of the surface layer 15 is less than 40%, the texture of an object displayed as an image deteriorates. In a case where the haze value of the surface layer 15 is greater than 85%, the blur of an image increases, and the resolution of the image decreases. Therefore, the haze value of the surface layer 15 is preferably in the above-described range. The haze value is in accordance with JIS K 7136:2000, and can be measured using a haze meter (HM-150 manufactured by Murakami Color Research Laboratory). The measurement is conducted such that parallel light is incident at an incident angle of 0° from the surface of the surface layer 15 having no projections or depressions (from the base material layer 151) .

The surface layer 15 is not limited to the above-described example, and may be in the following form. One or both of the projections-depressions layer 152 and the base material layer 151 of the surface layer 15 may contain particles serving as a diffusion material that diffuses light. The surface layer 15 may have a single-layer structure without the base material layer 151. Furthermore, the surface layer 15 may include, on its outermost surface, a reflection suppressing layer formed along the fine projections and depressions. The surface layer 15 may include a layer having at least one of an ultraviolet ray-absorbing function, an antistatic function, an antifouling function, a hard coat function, or the like.

From the viewpoint of improving the texture of an image, it is preferable that a distance S from a bottommost point in the uneven shape of the surface layer 15 that is closest to the back side to a surface that belongs to an image-forming layer configured to form an image and provided in the display panel 12 and that is closest to the observer side is 0.3 mm or less in the thickness direction (d direction) of the display panel 12. The image-forming layer is a liquid crystal layer in the case where the display panel 12 is a liquid crystal display panel as in the present embodiment. That is, in the present embodiment, the distance S can be adjusted by changing the thickness of a member (i.e., a CF substrate, a polarizing layer, and the like, which are not shown) disposed between the liquid crystal layer of the display panel 12 and the surface layer 15.

In a case where the distance S is greater than 0.3 mm, the image is visually perceived as being located inside the display panel 12 rather than on the outermost surface of the display device 10 serving as the display surface, so that a so-called sense of depth of image is produced, and the texture of the image deteriorates. Therefore, the distance S is preferably 0.3 mm or less.

The display control unit 20 and other units will be described with reference to FIG. 4. The sensor unit 25 detects the brightness and color of light in the environment in which the electronic apparatus 1 and the display device 10 are used, that is, the brightness and color of external light incident on the display surface 10a, and outputs the detected brightness and color to an image adjustment unit 21. The present embodiment will be described with reference to an example in which the sensor unit 25 detects the brightness and color of external light such as sunlight or illumination light incident on the point A at the center of the screen of the display surface 10a of the display device 10, and outputs the detected brightness and color to the image adjustment unit 21 of the display control unit 20. The sensor unit 25 may be configured as, for example, a general-purpose spectroradiometer or the like disposed outside the display device 10, an environmental light sensor or the like that is more compact and outputs color information (chromaticity) in accordance with the tristimulus colors XYZ of the CIE XYZ color system, or a light-receiving element or the like disposed inside the display panel 12.

The sensor unit 25 is not limited to the above-described examples, and may be configured to detect the brightness and color of external light at a plurality of points on the display surface 10a. In that case, the display surface 10a may be divided into a plurality of regions, and the sensor unit 25 may detect the brightness and color of external light at a point at the center of each region. Alternatively, for example, the display surface 10a may be divided into a plurality of regions, and a light-receiving element serving as the sensor unit 25 may be disposed in the display panel 12 at a center position of each region. In a case where light-receiving elements serving as the sensor unit 25 are disposed in the display panel 12, for example, each light-receiving element may be disposed in the vicinity of a pixel electrode in one pixel circuit. In that case, the light-receiving elements may be provided in all of the pixel circuits in the region serving as the display surface 10a, or may be disposed only at two or more selected positions. As the light-receiving element, a photodiode or the like can be used.

The display control unit 20 controls driving and the like of the backlight 11 and the display panel 12. The display control unit 20 includes the image adjustment unit 21, an electrode control unit 22, a light source control unit 23, etc. As the display control unit 20, a central processing unit (CPU) or the like can be used. The image adjustment unit 21 adjusts the brightness and color tone of an image to be displayed on the display surface 10a of the display device 10 based on the brightness and color of external light detected by the sensor unit 25. In the case where the sensor unit 25 detects the brightness and color of external light at one point on the display surface 10a, the image adjustment unit 21 adjusts the brightness and color tone of the entire image to be displayed on the screen, based on the information regarding the detected brightness and color of the external light. In the case where the sensor unit 25 detects the brightness and color of external light at a plurality of points on the display surface 10a, the image adjustment unit 21 may adjust the brightness and color of an image to be displayed, based on the two-dimensional distribution of the brightness and color of the external light on the display surface 10a. In particular, in the case where the sensor unit 25 is disposed in each pixel, the image adjustment unit 21 may adjust the brightness and color of the image in each pixel region.

The electrode control unit 22 controls a voltage to be applied between electrodes for driving the liquid crystal layer (not shown) of the display panel 12, in response to an instruction from the image adjustment unit 21. The light source control unit 23 controls brightness and the like of a light source (not shown) of the backlight 11, in response to an instruction from the image adjustment unit 21.

The storage unit 24 stores therein a computer program or data that defines a processing procedure or the like for the image adjustment unit 21 to adjust the brightness and color tone of an image to be displayed on the display surface 10a. In addition, the storage unit 24 temporarily stores data or the like necessary for the image adjustment unit 21 or the like to execute processing. As the storage unit 24, a memory element such as a read only memory (ROM), a random access memory (RAM), etc. can be used. The display control unit 20 of the present embodiment is capable of receiving an input of information or the like via the input unit or the communication unit of the electronic apparatus 1. It should be noted that this configuration is a non-limiting example, and the display device 10 may include an input unit and a communication unit.

By referring to FIG. 4, etc., it will be described how the electronic apparatus 1 and the display device 10 of the present embodiment display an image. First, an image to be displayed on the display surface 10a is outputted to the display control unit 20 of the display device 10 via the input unit or the communication unit of the electronic apparatus 1, thereby instructing the display control unit 20 to display the image. For example, as illustrated in FIG. 2, an image of a wood surface having a wood grain pattern on which characters are drawn is selected in the present embodiment.

Next, the image adjustment unit 21 instructs the sensor unit 25 to detect the brightness and the like of external light. The sensor unit 25 detects the brightness and color of external light incident on the display surface 10a. In the present embodiment, the sensor unit 25 detects the brightness and color of external light incident on the point A as the geometric center of the display surface 10a. The sensor unit 25 outputs the detection result to the image adjustment unit 21. The image adjustment unit 21 adjusts the brightness and color of the image to be displayed in accordance with the brightness and color of external light detected by the sensor unit 25. Specifically, the image adjustment unit 21 calls a program related to image processing from the storage unit 24, and calculates, based on the program, brightness and color of the wood and those of the characters that correspond to the brightness and color under the external light environment detected by the sensor unit 25. In accordance with the calculation result, the image adjustment unit 21 generates an image (hereinafter, referred to as an adjusted image) having brightness and color adjusted.

Next, based on the adjusted image, the image adjustment unit 21 outputs information necessary for driving the electrodes of the display panel 12 and information necessary for driving the light source of the backlight 11 to the electrode control unit 22 associated with the display panel 12 and the light source control unit 23 associated with the backlight 11. In the above-described manner, the display device 10 displays the adjusted image on the display surface 10a.

The surface layer 15 of the present embodiment is capable of allowing an observer to discern the texture of wood, stone, paper, a painting, fabric, or the like displayed as an image on the screen, and has an effect of enhancing the texture. Furthermore, the sensor unit 25, the image adjustment unit 21 of the display control unit 20, and other units allow the display device 10 to display an image in accordance with the brightness and color of external light in the environment in which the display device 10 is placed, thereby making it possible to further enhance the congruity between the image and the surrounding environment. As a result, the display device 10 and the electronic apparatus 1 can display an image that is congruent with the surrounding environment and has enhanced texture, thereby improving the design.

### Evaluation of Texture of Image Displayed by Display Devices of Measurement Examples 1 to 38

Display devices of Measurement Examples 1 to 38 respectively corresponding to examples of the display device 10 of the present embodiment and comparative examples were prepared, and the texture and the like of image displayed on the display surface were evaluated. The display devices of Measurement Examples 1 to 38 differ in the luminance distribution on the light-releasing surface 12a of the display panel 12, the arithmetic mean roughness Ra of the uneven shape of the surface layer 15, the distance S from the bottommost point in the uneven shape of the surface layer 15 to the liquid crystal layer serving as the image-forming layer, the haze value of the surface layer 15, and the like.

### Luminance Distribution on Light-Releasing Surface of Display Panel

First, the display devices of Measurement Examples 1 and 2 which were different in the luminance distributions of light released from the light-releasing surface 12a of the display panel 12 were prepared, and how the images appeared was evaluated. Here, the luminance distribution of the light released from the light-releasing surface 12a of the display panel 12 refers to a luminance distribution at a point B at the center of the light-releasing surface 12a. As an example, the measurement of the display devices of Measurement Examples 1 and 2 was performed on the light-releasing surface 12a in a direction corresponding to the left-right direction of the screen in the use state of the display device (e. g., a direction parallel to the long side of the display surface 10a in FIG. 2). The point B corresponded to the point A of the display surface 10a when viewed in the thickness direction of the display device. In each of the display devices of Measurement Examples 1 and 2, the luminance distribution in the direction passing through the point B of the light-releasing surface 12a and parallel to the up-down direction of the screen was equal to the luminance distribution in the direction passing through the point B and parallel to the left-right direction of the screen, or a difference therebetween was small enough to consider the luminance distributions to be equal to each other.

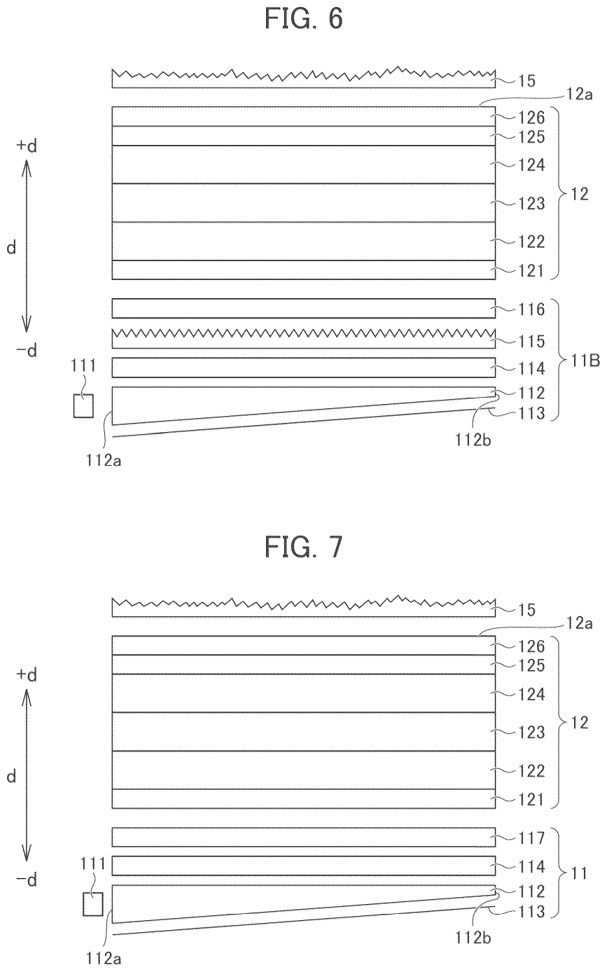

FIG. 6 is a diagram illustrating a configuration of the display device of Measurement Example 1. FIG. 7 is a diagram illustrating a configuration of a display device of Measurement Example 2. As illustrated in FIG. 6, the display device of Measurement Example 1 includes a surface layer 15, a display panel 12, and a backlight 11B. As illustrated in FIG. 7, the display device of Measurement Example 2 includes a surface layer 15, a display panel 12, and a backlight 11. The display device of Measurement Example 1 and the display device of Measurement Example 2 have the same configuration except that the optical members constituting the backlight are partially different between the Examples 1 and 2. The display device of Measurement Example 1 corresponds to a display device in which the surface layer 15 is laminated on the outermost surface of a commercially available display device (PV10109LZR40G manufactured by Kingtech Group Co., Ltd.).

Each of the display devices of Measurement Examples 1 and 2 has a screen size of 10.1 inches. The display panel 12 provided in in the display devices of Measurement Examples 1 and 2 includes a polarizing layer 121, a TFT substrate 122, a liquid crystal layer 123, a CF substrate 124, an optical film (phase difference film) 125, and a polarizing layer 126 in this order from the back side (backlight side) in the thickness direction. The display panel 12 is an IPS type liquid crystal display panel.

The backlight 11B of the display device of Measurement Example 1 includes a light source unit 111, a light guide plate 112, a reflector plate 113, a light diffusion sheet 114, a first prism sheet 115, and a second prism sheet 116. The backlight 11 of the display device of Measurement Example 2 includes a light source unit 111, a light guide plate 112, a reflector plate 113, a light diffusion sheet 114, and a Lambertian light diffusion plate 117.

The light source unit 111 is a member that emits light, and includes a plurality of LEDs arranged at equal intervals along a side surface (light incident surface 112a) of the light guide plate 112. The light guide plate 112 is a member that guides the light from the light source unit 111 toward the side surface 112b opposite to the light incident surface 112a. The reflector plate 113 is a member that reflects the light, which has been released from the light guide plate 112 toward the back side, to return the light to the light guide plate 112. The light diffusion sheet 114 is an optical member that diffuses and spreads the light released from the light guide plate 112, and has a nondirectional diffusion action.

Each of the first prism sheet 115 and the second prism sheet 116 included in the backlight 11B of Measurement Example 1 is an optical sheet having a plurality of unit prisms arranged on its surface facing the observer side (+d side), and has a function of directing light released from the light diffusion sheet 114 toward the front by means of the unit prisms. The unit prisms extend in one direction along the sheet surface, have a bilateral triangle shape in cross section, and are arranged in a direction intersecting with the longitudinal direction. The arrangement direction of the unit prisms of the first prism sheet 115 is orthogonal to the arrangement direction of the unit prisms of the second prism sheet 116 when viewed in the thickness direction of the display device. In the present embodiment, the arrangement direction of the unit prisms of the first prism sheet 115 coincides with the up-down direction of the screen, and the arrangement direction of the unit prisms of the second prism sheet 116 coincides with the left-right direction of the screen.

The Lambertian light diffusion plate 117 included in the backlight 11 of Measurement Example 2 is an optical sheet that diffuses and releases parallel light incident thereon, and is a diffusion sheet that makes the released light be in Lambertian distribution. In this example, a diffuse transmission sheet (Zenith Polymer Lambertian Diffusion Transmission Sheet SG3201 manufactured by SphereOptics GmbH) was used as the Lambertian light diffusion plate 117.

The luminance distribution of the display device of each measurement example was measured from −80° to 80° in the left-right direction of the screen at point B of the light-releasing surface 12a by using a conoscope manufactured by Autoronic Co., Ltd. in a state in which the display device of each measurement example was displaying a white screen.

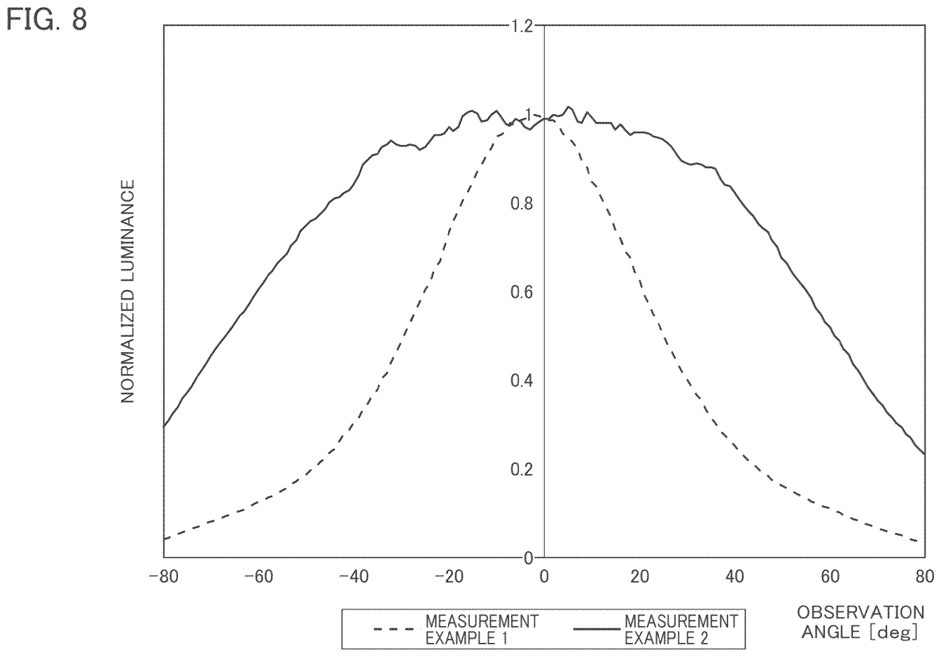

FIG. 8 is a graph showing the luminance distribution on the light-releasing surface 12a of the display panel 12 of the display devices of Measurement Examples 1 and 2. In the graph of FIG. 8, the vertical axis represents normalized luminance, and the horizontal axis represents an observation angle (an angle formed with respect to the normal direction of the screen). In the graph of FIG. 8, the luminance at each observation angle is normalized with reference to the front luminance defined as 1 for the display devices of Measurement Examples 1 and 2. As shown in FIG. 8, the luminance of the display device of Measurement Example 1 decreases as the observation angle increases, and a ½ angle is reached at about 25 degrees. In contrast, the luminance of the display device of Measurement Example 2 decreases less even when the observation angle increases.

In the display device of Measurement Example 1, the luminance at an observation angle of 60° is lower by a percentage decrease of about 83.3% relative to the luminance at an observation angle of 0° (front luminance). On the other hand, in the display device of Measurement Example 2, the luminance at an observation angle of 60° is lower by a percentage decrease of about 43.6% relative to the luminance at an observation angle of 0° (front luminance). The percentage decrease in luminance is an average value of the percentage decrease at an observation angle of +60° and the percentage decrease at an observation angle of −60°.

The display devices of Measurement Examples 1 and 2 having the surface layer 15 disposed on the light-releasing surface 12a of the display panel 12 were made to display an image of the wood grain pattern of the same wood surface on the screen, and the texture and the like appearing thereon were evaluated. The surface layer 15 included in the display devices of Measurement Examples 1 and 2 had an uneven shape with projections and depressions having an arithmetic mean roughness Ra of 100 μm and had a haze value of 60%. An illuminance spectrophotometer CL-500A manufactured by Konica Minolta, Inc. was used as the sensor unit 25 to measure the brightness and color of external light at the point A at the center of the display surface 10a. The brightness and color of the image were adjusted by the display control unit 20, and the adjusted image was displayed on the display surface 10a of the display devices of Measurement Examples 1 and 2.

The evaluation of the texture of the displayed image was performed in a state where the external light incident on the point A of the display surface 10a had a brightness of 100 lx, and had a color having xy coordinates of x=0.303826 and y=0.329804 in the CIE chromaticity diagram. These were measured by the sensor unit 25 (illuminance spectrophotometer CL-500A manufactured by Konica Minolta, Inc.).

The evaluation of the texture of the displayed image was performed in a bright room environment by an observer who observed the displayed image from a position 30 cm away from the point A, which is the center of the screen, in a direction at 60 degrees with respect to the normal direction of the display surface 10a (observation angle of 60 degrees).

The evaluation of the texture of the image displayed on the display surface 10a of the display devices of Measurement Examples 1 and 2 is as follows. For the display device of Measurement Example 1, as the observation angle increased, the brightness of the image significantly decreased. That is, the brightness of the image changed steeply depending on the observation angle. Therefore, in the display device of Measurement Example 1, it was difficult for the observer to discern the texture of the surface of the wood from the image the observer visually perceived.

On the other hand, in the display device of Measurement Example 2, the brightness of the image changed little by little depending on the observation angle, so that the observer could observe the image regardless of the observation angle. In addition, the observer could sufficiently discern the texture of the surface of the wood from the displayed image the observer visually perceived, and could recognize the characters as being written on the plate.

Additionally, an observation was performed on the display device of Measurement Example 2 having a portion of the surface layer 15 removed therefrom. The observer visually perceived reflection of external light or the like in the portion where the surface layer 15 was removed, and visually recognized a flat surface of the display surface, whereby it was difficult for the observer to discern the texture of the wood grain.

### Regarding Arithmetic Mean Roughness Ra of Uneven Shape and Distance S

Next, display devices of Measurement Examples 3 to 28 were prepared which were different in the arithmetic mean roughness Ra of the uneven shape of the surface layer 15 and the distance S between the bottommost point in the uneven shape (the point in the uneven shape that is closest to the back side (−d side)) and a point on the liquid crystal layer 123 closest to the observer side (+d side). The texture of an image displayed on the display surface 10a of these display devices was evaluated.

The display devices of Measurement Examples 3 to 28 included the same display panel 12 and backlight 11 as those of Measurement Example 2, but differed in the distance S and the arithmetic mean roughness Ra. Also in the evaluation of the display device of each measurement example, the brightness and color of external light at the point A on the display surface 10a were measured by the sensor unit 25, the brightness and color of the image were adjusted by the display control unit 20, and the adjusted image was displayed. The position from which the image displayed by the display device of each measurement example was observed, the external light conditions, and the like were as described above.

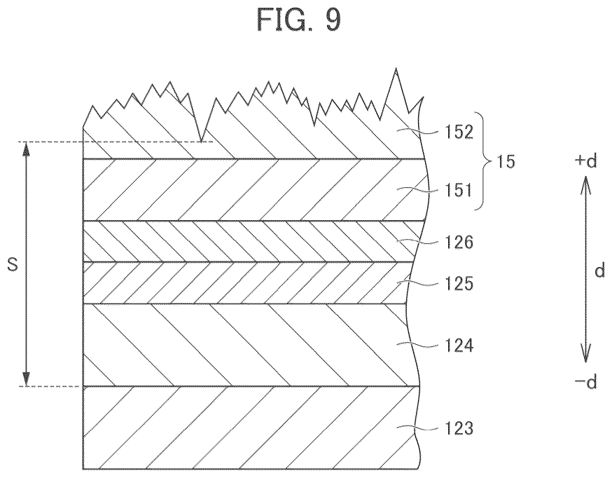

FIG. 9 is a diagram illustrating a distance S in a display device of an arbitrary one of the measurement examples. FIG. 9 shows, at an enlarged scale, a portion of a cross section parallel to the thickness direction (d direction) of the display device of the arbitrary one of the measurement examples. In the display devices of Measurement Examples 3 to 28, as shown in FIG. 9, the distance S is from the bottommost point in the uneven shape of the surface layer 15 closest to the back side to the surface of the liquid crystal layer 123 closest to the observer side. The distance S can be adjusted by changing the thickness or the like of the members disposed between the liquid crystal layer 123 and the surface layer 15, namely, the CF substrate 124, the optical sheet 125, and the polarizing layer 126.

Each display device had one of the following five example values of the arithmetic mean roughness Ra of the uneven shape of the surface layer 15: 5 μm, 8 μm, 10 μm, 3000 μm, and 7000 μm. Each display device had one of the following six example values of the distance S: 0.15 mm, 0.20 mm, 0.25 mm, 0.3 mm, 0.5 mm, and 0.7 mm. In the display devices of Measurement Examples 3 to 28, the projections-depressions layer 152 of the surface layer 15 contained a diffusing material (Micropearl with an average particle diameter of 10 μm, manufactured by Sekisui Chemical Co., Ltd.) that diffuses light, and the haze value of the surface layer 15 of each display device is adjusted to be approximately 60% regardless of the arithmetic mean roughness Ra of the uneven shape.

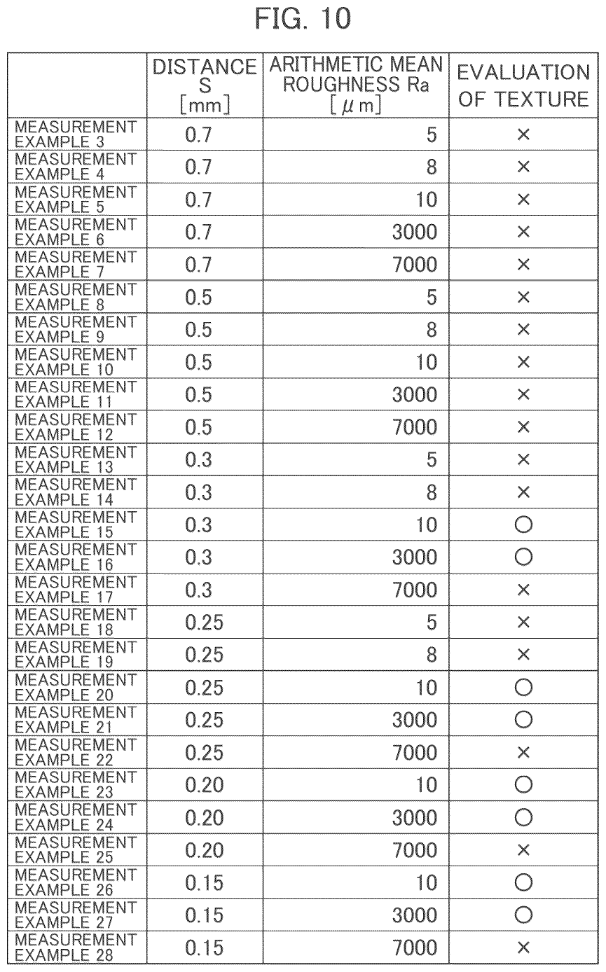

FIG. 10 is a table showing the evaluation results of the textures of the images displayed by the display devices of Measurement Examples 3 to 28. In the column headed with “Evaluation of Texture” in the table of FIG. 10, a case where the observer who visually perceived the image discerned the texture is evaluated as good (indicated by circle symbol “o”), and a case where it was difficult for the observer who visually perceived the image to discern the texture was evaluated as unacceptable (indicated by cross symbol “x”). As shown in the table of FIG. 10, as the arithmetic mean roughness Ra of the uneven shape increased, the blur of the image increased, and the texture of the object could not be discerned. In the case where the arithmetic mean roughness Ra of the uneven shape of the surface layer 15 was less than 10μ, e.g., 5 μm or 8 μm, the projections and depressions were too small to allow the observer to visually perceive the roughness of the surface of the object displayed as the image, and the observer could not discern the texture from the image.

As the distance S increased, a sense of depth of the image (a state in which an observer feels that an image is displayed inside the display panel 12 with respect to the display surface, i.e., in the depth of the screen) became stronger, and it was difficult for the observer to discern the texture of the object. For example, in a case where the distance S was set to 0.3 mm or shorter, i.e., 0.25 mm, 0.20 mm, or 0.15 mm and the arithmetic mean roughness Ra of the uneven shape was 10 μm or 3000 μm, the sense of depth was suppressed and the texture was discerned from the image. However, in a case where the arithmetic mean roughness Ra was 7000 μm, the blur of the image increased regardless of the value of the distance S, and it was difficult for the observer to discern the texture from the image.

The foregoing indicates that setting the arithmetic mean roughness Ra of the uneven shape of the surface layer 15 to 10 μm or greater and 3000 μm or less makes it possible to improve the texture of an object in an image. Setting the distance S to 0.3 mm or less makes it possible to suppress the sense of depth of an image and improve the texture of an object in the image.

### Regarding Haze Value of Surface Layer 15

Next, display devices of Measurement Examples 29 to 38 were prepared which were different in the haze value of the surface layer 15 and the arithmetic mean roughness of the uneven shape, and the textures of images were evaluated in the same manner. The display devices of Measurement Examples 29 to 38 each included the same display panel 12 and backlight 11 as those of Measurement Example 2, but differed in the haze value of the surface layer 15 and the arithmetic mean roughness Ra of the uneven shape. The display devices of Measurement Examples 29 to 38 had the same distance S, which was 0.25 mm.

The display devices of Measurement Examples 29 to 33 had the same arithmetic mean roughness Ra of the uneven shape, which was 10 μm, but had different haze values, namely 90%, 85%, 60%, 40%, and 25%, respectively. The display devices of Measurement Examples 34 to 38 had the same arithmetic mean roughness Ra of 3000 μm, but had different haze values, namely 90%, 85%, 60%, 40%, and 25%, respectively. In each of the display devices of Measurement Examples 29 to 38, the projections-depressions layer 152 of the surface layer 15 contained a light diffusing material (Micropearl with an average particle diameter of 10 μm, manufactured by Sekisui Chemical Co., Ltd.), and the haze value of the surface layer 15 was adjusted by adjusting the content of the light diffusing material.

Also in the evaluation of the display device of each measurement example, the brightness and color of external light at the point A on the display surface 10a were detected by the sensor unit 25, and an image with brightness and color adjusted by the display control unit 20 was displayed. The position from which the image displayed by the display device of each measurement example was observed, the external light conditions, and the like were as described above.

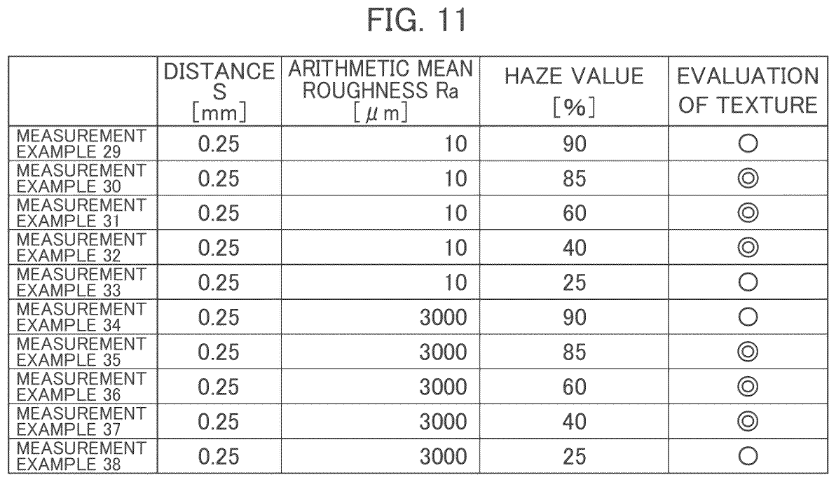

FIG. 11 is a table showing the evaluation results of the textures of the images displayed by the display devices of Measurement Examples 29 to 38. In the column headed with “Evaluation of Texture” in the table of FIG. 11, a case where the observer who visually perceived the image sufficiently discerned the texture is evaluated as excellent (indicated by bullseye symbol “⊙”), and a case where the observer discerned the texture but recognized deterioration of the texture as compared with the case evaluated as excellent was evaluated as good (indicated by circle symbol “o”). The observation position of the observer with respect to the display surface 10a at the time of evaluation, ambient light, and the like were as described above. As shown in the table of FIG. 11, it was found that the higher the arithmetic mean roughness Ra of the uneven shape of the surface layer 15, the higher the haze value required in order to discern the texture of an object. For example, in the case where the arithmetic mean roughness Ra of the uneven shape of the surface layer 15 was 3000 μm, when the haze value of the surface layer 15 was 40% to 85%, the texture of the object displayed as the image could be discerned, and particularly, when the haze value of the surface layer 15 is 85%, the texture was discerned to be more pronounced. On the other hand, when the arithmetic mean roughness Ra of the uneven shape of the surface layer 15 was 10 μm, the texture was discerned to be pronounced despite the haze value of 40%.

In the case where the haze value of the surface layer 15 was less than 40%, the transparency of the surface layer 15 increased, so that the sense of depth of image increased, and the observer recognized that the texture of the image deteriorated in comparison with the case where the haze value of the surface layer 15 was 40% to 85%. In the case where the haze value of the surface layer 15 was greater than 85%, the sense of depth of image decreased, but the blur of the image became too greater in comparison with the case where the haze value of the surface layer 15 was 40% to 85%, whereby the observer firmly recognized the displayed image as an image, and recognized that the texture of the object deteriorated. As such, the haze value of the surface layer 15 is preferably 40% or greater and 85% or less.

The foregoing indicates that, in order to allow an observer to discern the texture of an image displayed on the display surface 10a, it is preferable that the display device 10 is configured to satisfy the following conditions and the electronic apparatus 1 includes the thus-configured display device 10. Preferably, the display device 10 includes, at a position closest to the observer side (+d side), the surface layer 15 having an uneven shape with irregular projections and depressions on a side facing the observer side, the uneven shape has an arithmetic mean roughness Ra of 10 μm or greater and 3000 μm or less, the surface layer 15 has a haze value of 40% or greater and 85% or less, the distance S from a bottommost point in the uneven shape to a surface of the image-forming layer (the liquid crystal layer in the present embodiment) closest to the observer side in the thickness direction of the display device 10 is 0.3 mm or less, and on a surface (the light-releasing surface of the display panel 12 in the present embodiment) on which the surface layer 15 is laminated, a luminance at an observation angle of 60° is lower by a percentage decrease of 45% or less relative to a luminance at an observation angle of 0° (front luminance). The display device 10 preferably further includes the sensor unit 25 that detects the brightness and color of external light incident on the display surface 10a, and the image adjustment unit 21 that adjusts the brightness and color of the image to be displayed by the display device 10 based on information regarding the brightness and color of external light detected by the sensor unit 25. Due to this configuration, the display device 10 can display an image that has brightness and color adjusted according to the brightness and color of ambient external light and that allows an observer to discern the texture of an object displayed as the image.

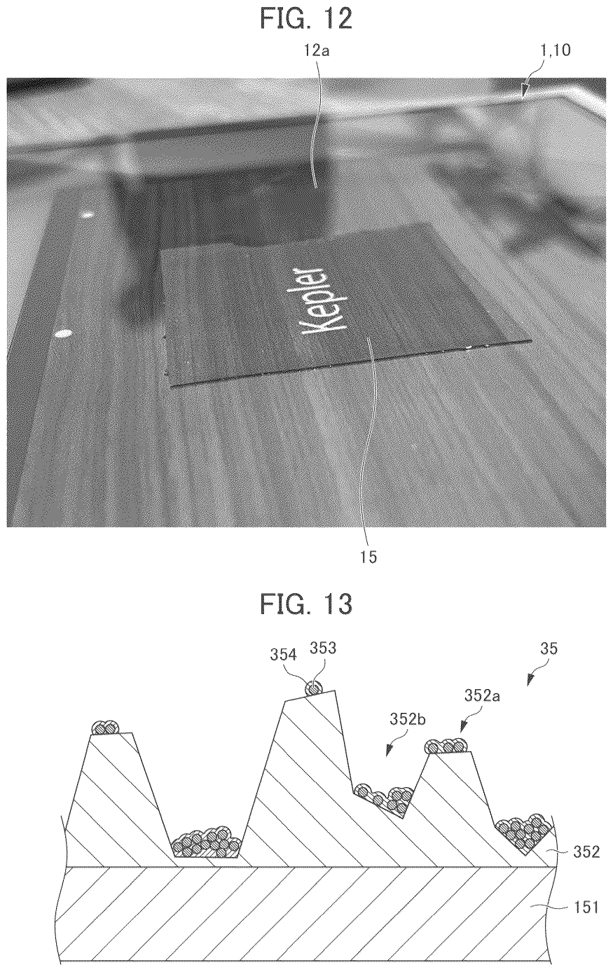

FIG. 12 is a photograph showing an example of the display device 10 and the electronic apparatus 1 including, in a portion of the light-releasing surface 12a, the surface layer 15 having an uneven shape with projections and depressions satisfying the preferred ranges of the arithmetic mean roughness Ra, the haze value, and the distance S. The display device 10 and the electronic apparatus 1 of the embodiment shown in FIG. 12 includes the same backlight 11 and the same display panel 12 as those included in the display device of Measurement Example 2. FIG. 12 shows a state in which the surface layer 15 is disposed on a portion of the light-releasing surface 12a of the display panel 12. The brightness and color of the displayed image are adjusted by the sensor unit 25, the image adjustment unit 21, and the like. The image displayed on the display surface of the display device 10 of the embodiment is of characters “Kepler” written with a light brown paint on a wood grain pattern of a brownish wood. The surface layer 15 is disposed in a region where the characters are displayed. The photograph shown in FIG. 12 was taken from a direction of 60° with respect to the normal direction of the light-releasing surface 12a in a room with white light illumination (100 lx).

The surface layer 15 shown in FIG. 12 has a haze value of 50%, and the uneven shape thereof has an arithmetic mean roughness of 100 μm. Furthermore, in the display device 10 of the example shown in FIG. 12, the distance S is 0.3 mm, and a luminance at an observation angle of 60° is lower by a percentage decrease of 43.65% relative to a luminance at an observation angle of 0°.

As shown in FIG. 12, in the portion where the surface layer 15 is not disposed, the smoothness of the light-releasing surface 12a serving as the display surface is visually perceived by the observer due to reflection of the illumination light and the like, and the texture of the wood was not discerned. In contrast, in the region where the surface layer 15 is disposed, the texture of wood is greatly improved, and it is observed that the characters are written on the wood grain pattern of the wood.

### Another Embodiment 1

It is possible to cause the surface layer 15 to further improve the texture of an image by adjusting the angles of the inclined surfaces of the projections and depressions, the distribution of the projections and depressions, and the like in accordance with the uneven shape of a surface of an object (wood grain, paper, woven fabric, stone, etc.) whose texture is desired to be improved, and by adjusting the distribution of haze values on the outermost surface of the uneven shape. Specifically, from the viewpoint of further improving the texture, the two-dimensional distribution of the haze values in a plan view of the display layer is preferably adjusted in accordance with the uneven shape.

FIG. 13 is an enlarged view of a portion of a cross section of a surface layer 35 according to another embodiment 1. The portion illustrated at an enlarged scale in FIG. 13 is of a cross section parallel to a thickness direction of the surface layer 35. The surface layer 35 of embodiment 1 is disposed on the light-releasing surface 12a of the display panel 12, as in the case of surface layer 15 of the above-described embodiment. The surface layer 35 includes a base material layer 151 and a projections-depressions layer 352. The base material layer 151 is the same as the base material layer 151 of the surface layer 15 of the above-described embodiment. The projections-depressions layer 352 is similar to the projections-depressions layer 152 of the above-described embodiment, but has a different distribution of haze values on the outermost surface of the uneven shape.

The surface layer 35 has a non-uniform distribution of the haze values in its plane direction. Specifically, the haze values of the outermost surface of the uneven shape of the surface layer 35 are in a non-uniform two-dimensional distribution in the plane direction of the surface layer 35. This non-uniform haze value distribution follows the irregular projections and depressions of the uneven shape. On the outermost surface of the uneven shape, the haze value of projections 352a is lower than the haze value of depressions 352b. The uneven shape of the surface layer 35 includes a plurality of projections 352a and a plurality of depressions 352b. The surfaces of the plurality of projections 352a have different haze values, and the surfaces of the plurality of depressions 352b have different haze values. Therefore, when the surface layer 35 is viewed in a plan view, the haze values of the surface layer 35 are in a two-dimensional distribution corresponding to the distribution of the projections and depressions in the plane direction of the surface layer 35, and the values thereof are in a non-uniform distribution. In the surface layer 35 of the embodiment 1, the projections-depressions layer 352 has an uneven shape simulating a wood grain, and the haze value on the surfaces of the projections 352a is lower than the haze value on the surfaces of the depressions 352b.

Due to the above-described configuration, when the surface layer 35 is irradiated with external light such as sunlight or illumination light, regions corresponding to the projections 352a of the uneven shape have a high specular reflectance, whereas regions corresponding to the depressions 352b have a low specular reflectance. Thus, in a case where an observer observes the display surface of the display device in a direction of specular reflection of external light, the regions corresponding to the projections 352a are visually perceived brighter than the regions corresponding to the depressions 352b, and the observer can visually perceive the uneven shape more clearly. Accordingly, the observer can discern the texture of the object displayed on the display surface to be more pronounced.

The outermost surface of the uneven shape can be imparted with the haze values by applying a resin 354 containing particles 353 having a particle diameter smaller than the projections and the depressions to the surfaces of the projections and the depressions. The two-dimensional distribution of the haze values in the plane direction of the surface layer 35 can be controlled by adjusting the amount of the particles 353 to be applied, in accordance with the projections and the depressions.

Suitable examples of the particles 353 include plastic beads, such as styrene beads, melamine beads, acrylic beads, acrylic-styrene beads, polycarbonate beads, polyethylene beads, etc. The particles 353 and the resin 354 containing the particles 353 preferably have light transmittance. The plastic beads used as the particles 353 preferably have a hydrophobic group on a surface. It is preferable that a refractive index ratio between the particle 353 and the resin 354 (refractive index of the particle 353/refractive index of the resin 354) is set to 1.0 to 1.1.

As illustrated in FIG. 13, the particles 353 may be covered with the resin 354, or may partially protrude from the layer of the resin 354. As the particles 353, two or more kinds of particles may be used. For example, in the case of using two kinds of particles, it is preferable that the two kinds of particles are different in one or more of average particle diameter, shape, material, refractive index ratio with respect to the resin 354, and the like. Also in this embodiment, the total haze value of the surface layer 35 is preferably in the range of 40% or greater and 85% or less.

### Evaluation Regarding Presence or Absence of Distribution of Haze Values

Samples A and B were prepared to evaluate textures that actually appeared. Specifically, the sample A was an example of the surface layer 35 in which the haze value of the surfaces of the projections 352a and the haze value of the surfaces of the depressions 352b were different from each other, whereas the sample B was an example of the surface layer 15 in which the haze values were not different between the projections and the depressions. The sample B had the uneven shape on its surface, but did not have a distribution of haze values corresponding to the projections and depressions. The sample A had the uneven shape similar to that of the sample B, the outermost surface of the uneven shape was coated with the resin 354 containing the particles 353, and the haze value of the surfaces of the projections 352a was lower than the haze value of the surfaces of the depressions 352b. The uneven shape of each of the samples A and B simulated a wood grain pattern, and had an effect of improving the texture of the wood grain displayed as an image.

The texture was evaluated under the following conditions. Two linear polarizing plates were laminated on a transparent glass plate so that the polarization directions thereof were orthogonal to each other, and the samples A and B were placed adjacent to each other on the linear polarizing plate, thereby preparing a laminate 40. The laminate 40 was irradiated with illumination light serving as external light, and an observer observed and evaluated the textures shown in the regions where the samples A and B were disposed. The laminate 40 was irradiated with the illumination light such that the illuminance at the center of the surface of the laminate 40 was 100 lx.

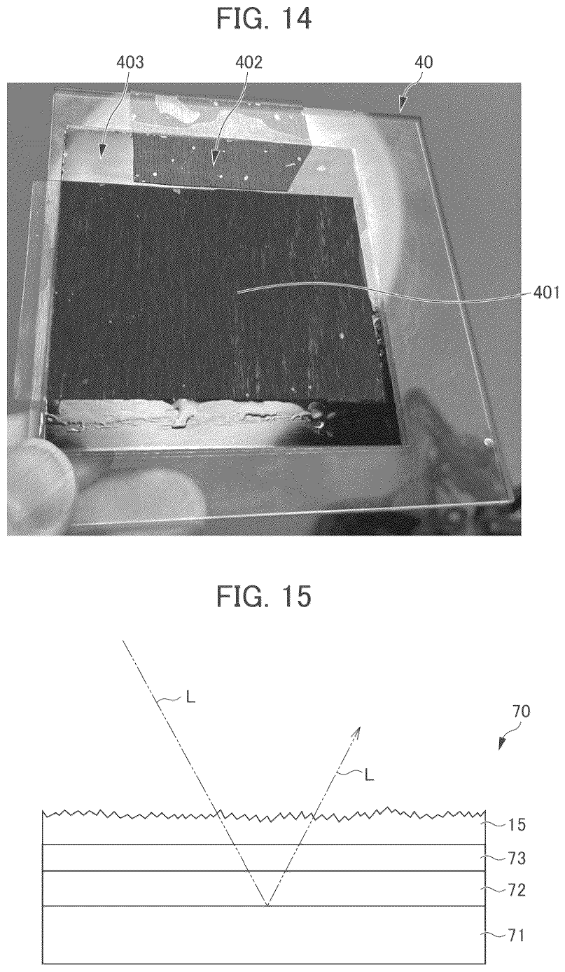

FIG. 14 is a photograph showing a state of the surface of the laminate 40. In FIG. 14, illumination light serving as main external light is incident on the surface of the laminate 40 at an incident angle of 40 degrees. The state shown in FIG. 14 is an observation in a specular reflection direction of the illumination light. A region 403 is where the two linear polarizing plates are laminated on the glass plate and the surface layer is not provided. Since the two polarizing plates are disposed with their polarizing directions being orthogonal to each other, the region 403 exhibits black color, but as shown in FIG. 14, the region 403 is visually perceived to be whitish due to reflection of the illumination light.

A region 402 is where the sample B corresponding to the example of the surface layer 15 is provided on the two linear polarizing plates laminated on the glass plate. The reflection of the illumination light is suppressed in the region 402, as compared with the region 403 where the surface layer is not provided, and the region 402 is visually perceived to be dark. Furthermore, in the region 402 where the sample B is provided, the uneven shape causes the wood grain pattern to be visually perceived, and the texture of the wood grain is discerned. However, part of the external light is uniformly specularly reflected on the surface of the uneven shape, and the region 402 is observed slightly brighter than a region 401 described later.

In contrast, in the region 401 where the sample A corresponding to the example of the surface layer 35 is provided on the two linear polarizing plates laminated on the glass plate, the light diffusion action of the particles 353 provided on the outermost surface of the uneven shape further enhances the matt texture that is characteristic to the surface of a wood. In addition, in the region 401, the projections 352a are visually perceived to be bright and the depressions 352b are visually perceived to be dark. Thus, the state in which the brightness changes along the wood grain pattern is visually recognized, whereby, the texture of the wood grain is reproduced more pronouncedly. Therefore, the texture of the wood grain is more enhanced in the region A where the sample A is provided than in the region 402 where the sample B is provided.

The foregoing indicates that the haze values on the outermost surface of the uneven shape of the surface layer 35 are preferably in a non-uniform distribution in the plane direction of the surface layer 35. In addition, in the uneven shape of the surface layer 35, it is preferable that the projections 352a have a lower haze value than the depressions 352b.

### Another Embodiment 2

In a liquid crystal display device such as the display device 10 of the present embodiment, when external light enters the display panel 12 that displays an image, part of the external light is reflected not only on the outermost surface of the display panel 12 but also inside the display panel 12. When the reflected light reaches the observer, the reflected light is recognized as glare, and the texture of an object displayed on the display surface 10a deteriorates. Therefore, it is desirable that the reflectance of external light inside the display device 10, in particular, the specular reflectance of external light inside the display panel 12 of the display device 10 of the present embodiment is 1% or less.

Such a display panel 12 can be realized, for example, by disposing a circular polarizing plate on the observer side relative to the liquid crystal layer instead of the conventional polarizing plate that is provided on the observer side relative to the liquid crystal layer. With the above-described display device according to the embodiment 2, the observer who observes the image of an object displayed on the display surface can discern the texture of the object to be more pronounced.

### Evaluation Regarding Reflectance of External Light Inside Display Device

A laminate 70 having the flowing structure was prepared, and the effect of improving the texture by the surface layer due to the reflectance of external light inside the display device was evaluated. FIG. 15 is a diagram illustrating a layered structure of the laminate 70. In FIG. 15, diffusion, refraction, and the like of external light L are omitted for ease of understanding. The laminate 70 includes a mirror 71, two linear polarizing plates 72 and 73 laminated over the mirror 71, and a surface layer 15 disposed over the linear polarizing plates 72 and 73. The surface layer 15 has an uneven shape suitable for reproducing a wood grain pattern, and has a function of improving the texture of the wood grain pattern. The intersecting angle of the polarization directions of the two linear polarizing plates 72 and 73 is adjustable, thereby allowing for adjusting the specular reflectance of external light inside the laminate 70. The external light L (illumination light) is irradiated so as to be incident at an incident angle of 60 degrees with respect to the plane direction of the surface layer 15 of the laminate 70. The illuminance is 100 lx at the center of the surface of the surface layer 15.

The specular reflectance of the external light was measured using a spectroradiometer (SR-UL1 manufactured by Topcon Technohouse Corporation) in a state where the laminate 70 had the surface layer 15 removed therefrom. Specifically, the light for measurement was incident on the surface of the linear polarizing plate 73 at an incident angle of 5 degrees, and the spectroradiometer measured the light specularly reflected at a reflection angle of 5 degrees to calculate the specular reflectance. The observer observed and evaluated the texture in a direction at an angle of 60 degrees with respect to the normal direction of the plane direction of the surface layer 15.

In a case where the specular reflectance of the external light was 1% in the laminate 70, the light reflected by the mirror 71 was reduced, and the surface layer 15 allowed the observer to sufficiently discern the texture of the wood grain pattern. In a case where the specular reflectance in the laminate 70 was 1.5%, the light reflected by the mirror 71 was visually perceived, and the surface layer 15 allowed the observer to discern the texture of the wood grain pattern, but the observer recognized deterioration of the texture as compared with the case where the specular reflectance was 1%. In a case where the specular reflectance in the laminate 70 was 2%, the light reflected by the mirror 71 was visually perceived very strongly, and the surface layer 15 could not allow the observer to discern the texture of the wood grain pattern.

The foregoing indicates that the reflectance of external light inside the display device 10, particularly the specular reflectance of external light inside the display panel 12 of the display device 10 of the present embodiment, is desirably 1% or less.

### Modifications

The present invention is not limited to the embodiments described above, and various modifications and changes can be made within the scope of the present invention.
(1) The present invention has been described with reference to the example in which the display device 10 is a liquid crystal display device, but the present invention is not limited thereto. The display device 10 may be a plasma display, an organic EL display, or the like. In the case of the plasma display, the distance S is a distance from the bottommost point in the uneven shape of the surface layer 15 to an observer side-facing surface of a phosphor in the display. In the case of the organic EL display, the distance S is a distance from the bottommost point in the uneven shape of the surface layer 15 to an observer side-facing surface of an organic EL material layer in the display. In both cases of the plasma display and the organic EL display, the specular reflectance of external light in the display device is preferably 1% or less.
(2) For example, the display device 10 may be installed on an instrument panel of an automobile, as an interior of a vehicle or a ship, or for any other application.

The following additional remarks are further disclosed in relation to the above-described embodiments and modifications.

### Additional Remark 1

A display device for displaying an image on a display surface includes: a surface layer disposed closest to an observer side, having light transmittance, and having an uneven shape with projections and depressions on a side facing the observer side, the uneven shape has an arithmetic mean roughness Ra of 10 μm or greater and 3000 μm or less, the surface layer has a haze value of 40% or greater and 85% or less, in a thickness direction of the display device, a distance from a bottommost point in the uneven shape to an image-forming layer configured to form the image to be displayed is 0.3 mm or less, and on a surface with the surface layer laminated thereon, a luminance at an observation angle of 60° with respect to a normal direction of the surface is lower by a percentage decrease of 45% or less relative to a luminance in the normal direction of the surface.

### Additional Remark 2

The display device according to Additional Remark 1 further includes a sensor unit configured to detect brightness and color of external light incident on the display surface, and an image adjustment unit configured to adjust brightness and color of the image to be displayed by the display device based on information regarding the brightness and color of the external light detected by the sensor unit.

### Additional Remark 3

In the display device according to Additional Remark 1 or 2, in the uneven shape, the depressions have irregular depths, the projections have irregular heights, and the projections and the depressions are in an irregular distribution in a plane direction of the surface layer.

### Additional Remark 4

In the display device according to any one of Additional Remarks 1 to 3, haze values of an outermost surface of the uneven shape are in an irregular distribution in a plane direction of the surface layer.

### Additional Remark 5

In the display device according to any one of Additional Remarks 1 to 4, external light incident on the display device has a specular reflectance of 1% or less inside the display device.

### Additional Remark 6

An electronic apparatus includes the display device according to any one of Additional Remarks 1 to 5.

Although the present embodiment and the modifications can be appropriately combined to be used, detailed description of such a combination is omitted. It should be noted that the present invention is not limited to the above-described embodiments and the like.

### EXPLANATION OF REFERENCE NUMERALS

1: Electronic apparatus
10: Display device
11: Backlight
12: Display panel
15: Surface layer
151: Base material layer
152: Projections-depressions layer
20: Display control unit
21: Image adjustment unit
22: Electrode control unit
23: Light source control unit
24: Storage unit
25: Sensor unit

1. A display device for displaying an image on a display surface, the display device comprising:
a surface layer disposed closest to an observer side, having light transmittance, and having an uneven shape with projections and depressions on a side facing the observer side, wherein
the uneven shape has an arithmetic mean roughness Ra of 10 μm or greater and 3000 μm or less,
the surface layer has a haze value of 40% or greater and 85% or less,
in a thickness direction of the display device, a distance from a bottommost point in the uneven shape to an Image-forming layer configured to form the image to be displayed is 0.3 mm or less, and
on a surface with the surface layer laminated thereon, a luminance at an observation angle of 60° with respect to a normal direction of the surface is lower by a percentage decrease of 45% or less relative to a luminance in the normal direction of the surface,
the display device further comprising
a sensor unit configured to detect brightness and color of external light incident on the display surface, and
an image adjustment unit configured to adjust brightness and color of the image to be displayed by the display device based on information regarding the brightness and color of the external light detected by the sensor unit.

2. The display device according to claim 1, wherein
in the uneven shape, the depressions have irregular depths, the projections have Irregular heights, and the projections and the depressions are in an irregular distribution in a plane direction of the surface layer.

3. The display device according to claim 1, wherein
haze values of an outermost surface of the uneven shape are in an irregular distribution in a plane direction of the surface layer,

4. The display device according to claim 1, wherein
external light incident on the display device has a specular reflectance of 1% or less inside the display device.

5. An electronic apparatus comprising the display device according to claim 1.
